(19) United States
(12) Patent Application Publication
(10) Pub. No.: US 2016/0244855 A1
(43) Pub. Date: Aug. 25, 2016

(54) Method For Trimming A Hot Formed Part

(71) Applicants: Edward K. STEINEBACH, Oak Ridge, TN (US); Mark Justin JONES, Knoxville, TN (US); Jeremiah John BRADY, Knoxville, TN (US); Kenneth R. ADAMS, Troy, MI (US); MAGNA INTERNATIONAL INC., Aurora (CA)

(72) Inventors: Edward K. Steinebach, Oak Ridge, TN (US); Mark Justin Jones, Knoxville, TN (US); Jeremiah John Brady, Knoxville, TN (US); Kenneth R. Adams, Troy, MI (US)

(21) Appl. No.: 15/030,083

(22) PCT Filed: Oct. 21, 2014
(86) PCT No.: PCT/US2014/061519

§ 371 Date: Apr. 18, 2016

Related U.S. Application Data
(60) Provisional application No. 61/893,318, filed on Oct. 21, 2013.

(51) Int. Cl. C21D 9/00; C22C 38/32; C22C 38/28; C22C 38/22; C22C 38/06; B23K 26/40; C22C 38/02; C22C 38/00; C21D 8/00; C21D 7/13; C21D 6/00; B23K 26/38; C22C 38/38; C22C 38/04

(52) U.S. Cl. CPC C21D 9/0068; C22C 38/38; C22C 38/32; C22C 38/28; C22C 38/22; C22C 38/06; C22C 38/04; C22C 38/02; C22C 38/002; C21D 8/005; C21D 7/13; C21D 6/002; C21D 6/005; C21D 6/008; B23K 26/38; B23K 26/40; B23K 2203/04

(57) ABSTRACT

A method for manufacturing a hot formed part (20), such an automotive body component, is provided. The method includes heating a steel blank (22) to an austenite temperature, and quickly transferring the heated blank (22) to a hot forming apparatus (28). The method then includes forming the heated blank (22) between a pair of dies (24, 26), and trimming, piercing, shearing, or otherwise cutting the heated blank (22) or hot formed part (20) in the hot forming apparatus (28). The cutting step occurs while the microstructure of the steel blank (22) is substantially austenite, for example at a temperature of 400° C. to 850° C. The method can provide a hot formed part (20) having a desired shape in a single die stroke, without the need for a costly post-forming operation outside of the hot forming apparatus (28), such as laser trimming.

### CROSS-REFERENCE TO PRIOR APPLICATIONS

This U.S. National Stage Patent Application claims the benefit of PCT International Patent Application Ser. No. PCT/US2014/061519 filed Oct. 21, 2014 entitled “Method For Trimming A Hot Formed Part,” which claims the benefit of U.S. Provisional Patent Application Ser. No. 61/893,318 filed Oct. 21, 2013, entitled “Method For Trimming A Hot Formed Part,” the entire disclosures of the applications being considered part of the disclosure of this application and hereby incorporated by reference.

### BACKGROUND OF THE INVENTION

1. Field of the Invention

The invention relates generally to hot formed steel parts, such as automotive body components, and methods for manufacturing the hot formed steel parts.

2. Related Art

Automotive body components are oftentimes manufactured by hot forming a steel blank. The process includes heating the steel blank in an oven to a temperature of approximately 850° C. to 900° C. until the steel blank obtains an austenite microstructure. Next, the heated blank is transferred from the oven to a hot forming apparatus which includes a pair of dies. The heated blank is then stamped or pressed to a predetermined shape between the dies. The hot forming process also typically includes a quenching step to increase the strength of the hot formed part. During the quenching step, the hot formed part is cooled to a temperature low enough to transform the austenite microstructure to a martensite microstructure.

After the hot forming process, the hot formed part is removed from the dies and transferred to a separate location for at least one post-forming operation. The hot formed part is typically trimmed, pierced, sheared, or otherwise cut to achieve a desired shape. However, due to the high strength of the martensite microstructure present in the hot formed part, expensive post-forming processes and equipment are typically required to cut the hot formed part and achieve the desired shape. For example, a costly laser cutting process is oftentimes used to trim the hot formed part.

### SUMMARY OF THE INVENTION

The invention provides a method for manufacturing a hot formed steel part, such as an automotive body component, which is trimmed, pierced, sheared, or otherwise cut to a desired shape, without a costly post-forming operation, such as laser cutting. The method first includes heating a blank formed of steel material to a temperature of 880° C. to 950° C., and maintaining the blank at the temperature of 880° C. to 950° C. until the microstructure of the steel material is substantially austenite. The method then includes disposing the blank on a lower forming surface of a lower die while the blank is at a temperature of at least 400° C. and the microstructure of the blank is still substantially austenite. The heated blank is initially spaced from an upper forming surface of an upper die. The upper die is coupled to a cutting component, and the cutting component is disposed adjacent the upper forming surface.

The method next includes bringing the upper die toward the lower die to form and cut the heated blank. The step of bringing the upper die toward the lower die includes bringing the upper forming surface of the upper die into contact with the blank to form the blank between the upper and lower forming surfaces; and moving at least a portion of the upper die and the cutting component together longitudinally until the cutting component cuts at least a portion of the blank. The cutting step is conducted while the blank is at a temperature of at least 400° C. and the microstructure of the blank is substantially austenite.

The method further includes cooling the blank at a rate of at least 27 degrees per second. The cooling step is conducted while the upper forming surface and the lower surface remain in contact with the cut blank and until the microstructure of the cut blank includes martensite.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 illustrates a method of manufacturing a hot formed part according to an exemplary embodiment of the invention;

FIG. 2A is a cross-sectional view of a hot forming apparatus according to an exemplary embodiment of the invention immediately before a cutting step;

FIG. 2B is a cross-sectional view of a hot forming apparatus according to an exemplary embodiment of the invention immediately after a cutting step;

FIG. 3 is a cross-sectional view of a hot forming apparatus according to another exemplary embodiment of the invention;

FIG. 4 is a perspective view of an exemplary hot formed part showing an approximate temperature profile along the hot formed part at the start of a cutting step; and

FIG. 5 is a chart illustrating a load force applied to a hot formed part by a cutting component of a hot forming apparatus according to an exemplary embodiment of the invention.

### DETAILED DESCRIPTION

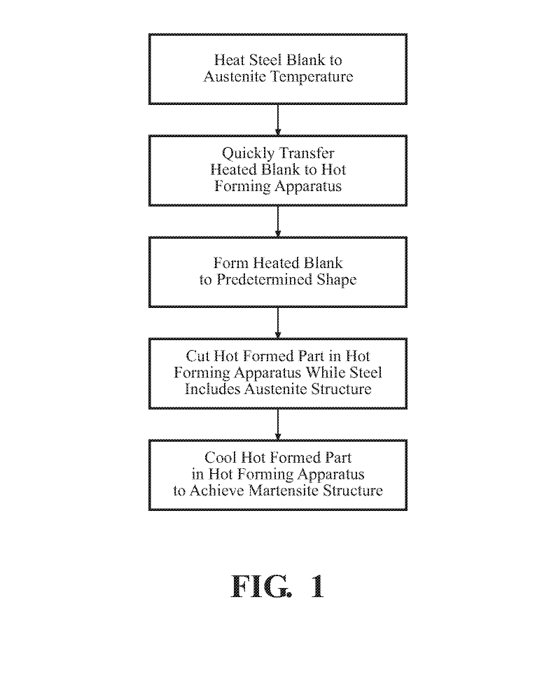

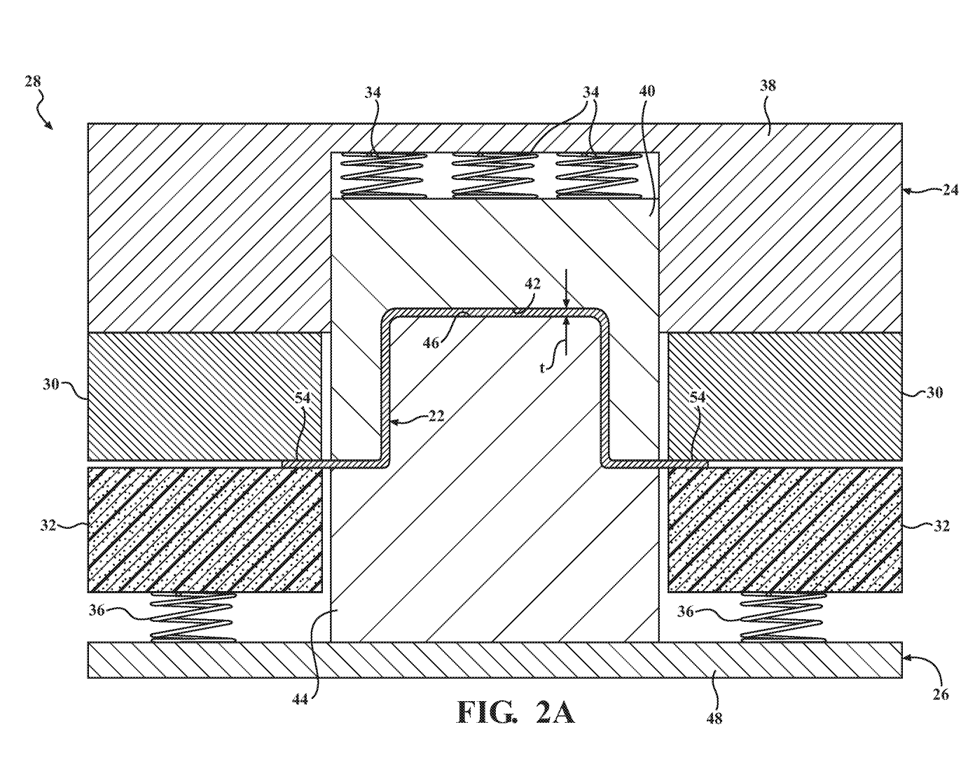

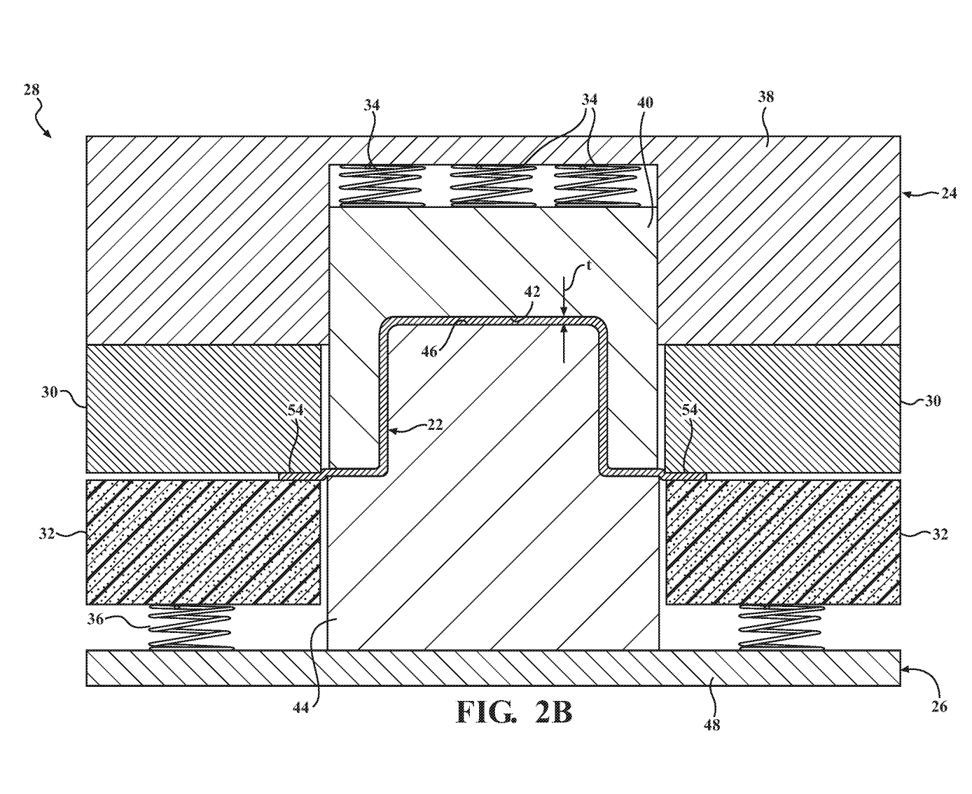

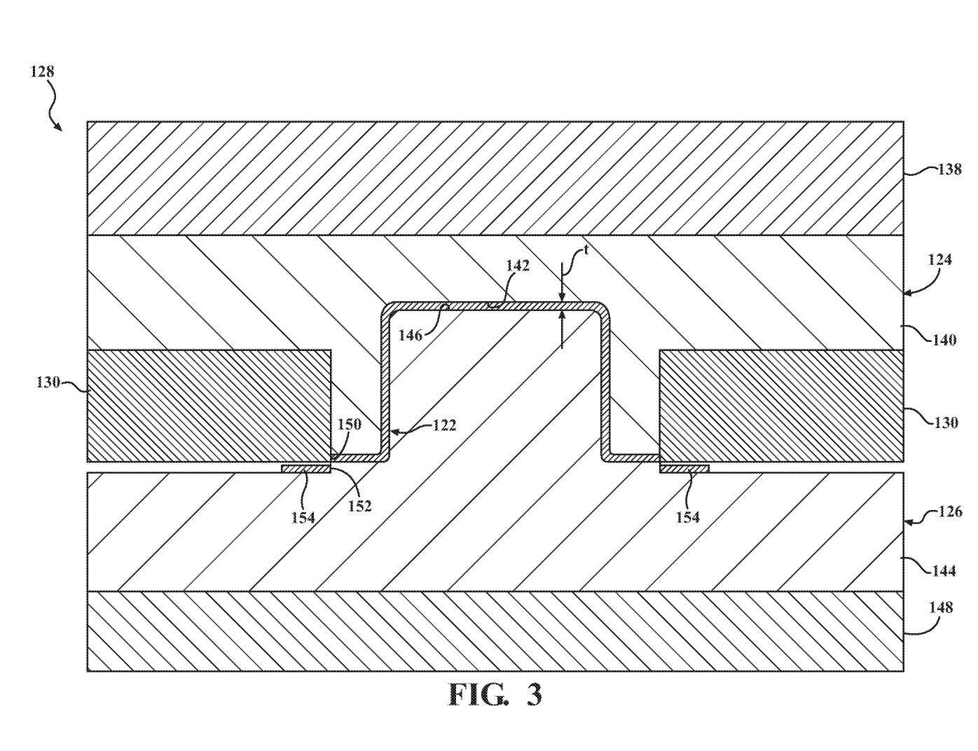

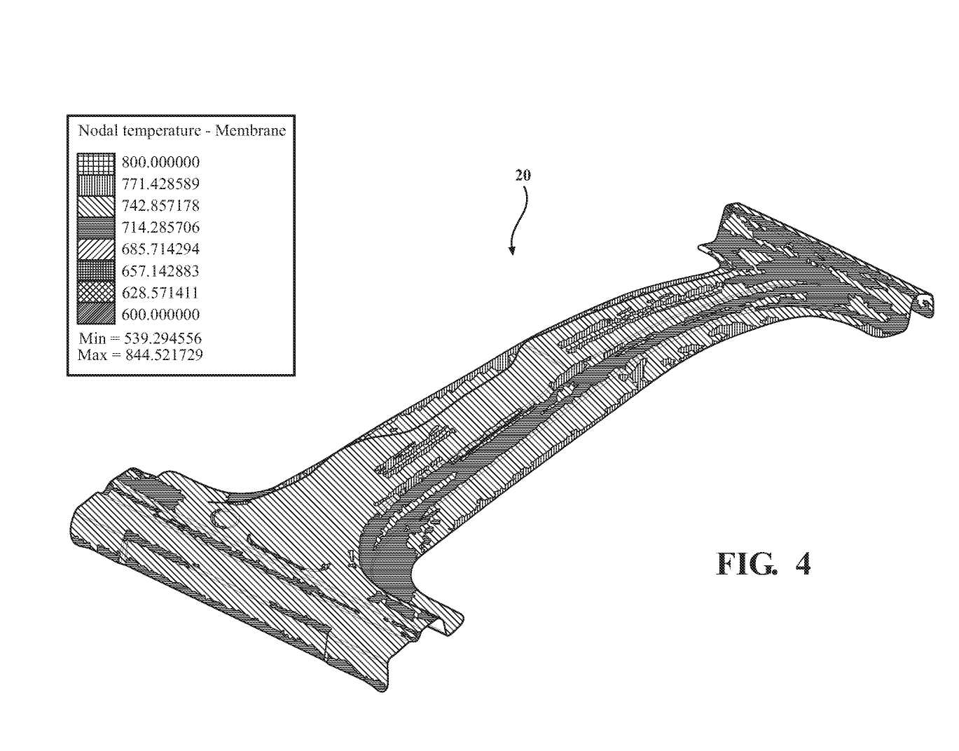

The invention provides an improved method for manufacturing a hot formed steel part 20, such as an automotive body component, without a costly post-forming operation. The method includes heating a steel blank 22 to an austenite temperature, and cutting the heated blank 22 while forming the heated blank 22, or immediately after forming the heated blank 22, between a pair of dies 24, 26 of a hot forming apparatus 28. The cutting step occurs while the microstructure of the blank 22 is still substantially austenite. FIG. 1 illustrates steps of the hot forming method according to an exemplary embodiment. FIGS. 2A, 2B, and 3 illustrate exemplary hot forming apparatuses 28, and FIG. 4 illustrates an exemplary hot formed part 20.

The method begins by providing the blank 22 formed of a steel material, which can be any type of steel material. In one embodiment, the steel material used to form the blank 22 comprises 0.18% to 0.28% carbon, 0.7% to 1.0% silicon, 1.0% to 2.0% manganese, 0.12% to 0.7% chromium, 0.1% to 0.45% molybdenum, 0.025% maximum phosphorus, 0.008% to 0.01% sulfur, 0.02% to 0.05% titanium, 0.01% to 0.06% aluminum, and 0.002% to 0.004% boron, based on the total weight of the steel material. In another embodiment, the steel material comprises a mixture of manganese and boron, for example 22MnB5. The size and shape of the blank 22 depends on the desired size, shape, and application of the hot formed part 20 to be manufactured. In one embodiment, the blank 22 is initially provided with a coating formed of aluminum and silicon (AlSi). This coating ultimately forms a diffusion layer along the surface of the hot formed part 20.

Once the blank 22 is provided, the method includes annealing or otherwise heating the blank 22 in an oven or furnace. The blank 22 is heated or annealed for a period of time causing an austenite microstructure to form throughout the steel material. The temperature and duration of the heating step varies depending on the dimensions of the blank 22 and type of steel material used. However, the blank 22 is typically heated to a temperature of 880° C. to 950° C. and is held at that temperature for at least 30 seconds to form the austenite microstructure. In one embodiment, the blank 22 is heated to a temperature of 910° C. for at least 20 seconds. In another embodiment, the blank 22 is heated to a temperature of 930° C. for at least 20 seconds. During the heating step, all carbides in the steel material of the blank 22 should dissolve so that there are no residual carbides. After the heating step, the microstructure of the steel material is substantially austenite, for example at least 75% austenite, or entirely austenite (100% austenite).

The heating step is adjusted slightly when the steel blank 22 is coated with the AlSi coating, as additional time is required for the AlSi coating to form a diffusion layer having a sufficient thickness along the surface of the blank 22. Maintaining the blank 22 at a temperature above 800° C. for at least 150 seconds is typically required for the AlSi coating to form a diffusion layer having a sufficient thickness. Additional heating time is also required due to the reflective nature of the AlSi coating at temperatures of 580° C. to 780° C.

Immediately following the heating step, the heated blank 22 is quickly transferred from the oven to the hot forming apparatus 28 while the blank 22 is still above the austenite temperature and thus still includes the substantially austenite microstructure. In one embodiment, the steel material of the blank 22 is entirely austenite when it enters the hot forming apparatus 28. In another embodiment, the steel material of the blank 22 includes at least 75% austenite, but less than 100% austenite, when it enters the hot forming apparatus 28. The blank 22 is transferred quickly to the hot forming apparatus 28 so that the temperature of the blank 22 stays above 400° C.

The method next includes forming and trimming, piercing, shearing, or otherwise cutting the heated blank 22 to a desired shape in the hot forming apparatus 28. The forming and cutting steps both occur in the hot forming apparatus 28 and during a single die stroke. In other words, the cutting step occurs simultaneously with the forming step or immediately thereafter. The blank 22 is at a temperature of at least 400° C., such as a temperature of 400° C. to 800° C. during the forming and cutting steps. In addition, the forming and cutting steps are both conducted while the steel material includes a 100% austenite microstructure or at least a substantially austenite microstructure.

FIGS. 2A and 2B illustrate an exemplary hot forming apparatus 28 in a closed position. In this embodiment, the hot forming apparatus 28 includes an upper die 24, a lower die 26, a cutting component 30, a pad 32, upper springs 34, and lower springs 36. The cutting component 30 and upper springs 34 are fixed to a first portion 38 of the upper die 24, for example by bolts. A second portion 40 of the upper die 24, referred to as an upper form, presents an upper forming surface 42 and is surrounded by the first portion 38 and the cutting component 30. The upper springs 34 are disposed on the second portion 40 and bias the first portion 38 away from the second portion 40. Thus, the first portion 38 and connected cutting component 30 are movable relative to the second portion 40 of the upper die 24. For example, when the upper springs 34 are compressed, the first portion 38 of the upper die 24 and cutting component 30 move together longitudinally such that the cutting component 30 moves past the upper forming surface 42 and toward the pad 32. The cutting component 30 is formed of a material capable of cutting the steel material of the blank 22. In the exemplary embodiments, the cutting component 30 is also formed of a steel material, referred to as trim steel.

As shown in FIGS. 2A and 2B, the lower die 26 includes a third portion 44, referred to as a lower form, which presents a lower forming surface 46 for supporting the steel blank 22. The lower springs 36 are fixed to a fourth portion 48 of the lower die 26, for example by bolts. The pad 32 is disposed on opposite sides of the lower forming surface 46 beneath the cutting component 30, and the lower springs 36 bias the pad 32 toward the cutting component 30 and the upper die 24. Although the Figures show the upper die 24 positioned above the lower die 26, the position of the hot forming apparatus 28 could be reversed such that the upper die 24 is positioned below the lower die 26.

Prior to the forming step, the hot forming apparatus 28 is in an open position, and thus the upper die 24 and cutting component 30 are spaced from the lower die 26 and pad 32. The geometry of the upper forming surface 42 and the lower forming surface 46 varies depending on the desired shape of the part 20 to be formed. In the embodiment of FIGS. 2A and 2B, the upper forming surface 42 is recessed, and the lower forming surface 46 is received in the recessed upper forming surface 42 when the apparatus 20 is closed. Also, prior to the forming step, when the hot forming apparatus 28 is open, no pressure is placed on the lower springs 36, such that the lower springs 36 are extended and the pad 32 is generally aligned with a portion of the lower forming surface 46.

The forming step occurs immediately after transferring the heated blank 22 to the hot forming apparatus 28, so that the temperature of the blank 22 stays above 400° C. In the embodiment of FIGS. 2A and 2B, the heated blank 22 is disposed on the uppermost portion of the lower forming surface 46 such that the edges of the heated blank 22 project outwardly of the lower forming surface 46 and are located above the pad 32. The forming step then includes bringing the first and second portions 38, 40 of the upper die 24 together with the cutting component 30 downwardly toward the lower die 26 and the heated blank 22. While the upper die 24 and cutting component 30 move downward toward the heated blank 22, the upper springs 34 are not compressed. Thus, the first portion 38 of the upper die 24 and the cutting component 30 do not move relative to the second portion 40 of the upper die 24 during the forming step.

As the upper die 24 moves downward, the upper forming surface 42 contacts and presses the heated steel blank 22 around the lower forming surface 46 to form the blank 22 to a predetermined shape, as shown in FIGS. 2A and 2B. The upper forming surface 42 presses the heated blank 22 until the edges of the heated blank 22 rest on or slightly above the pad 32 on opposite sides of the lower forming surface 46. The steel material of the blank 22 is still substantially austenite during the forming step, for example at least 75% austenite or 100% austenite.

The method further includes cutting the heated blank 22 to provide the desired shape while the blank 22 is still in the hot forming apparatus 28 and includes the substantially austenite microstructure. The cutting step occurs during the same die stroke as the forming step. In the exemplary embodiment of FIGS. 2A and 2B, the first portion 38 of the upper die 24 compresses the upper springs 34, and the first portion 38 and the cutting component 30 continue moving downward together while the second portion 40 of the upper die 24 remains in a fixed position. The cutting component 30 then moves longitudinally past the upper forming surface 42 while the upper forming surface 42 remains in contact with the heated blank 22. During the cutting step, the cutting component 30 cuts at least a portion of the steel blank 22. In one embodiment, the cutting component 30 moves past the lower forming surface 46 and shears the edges off the blank 22. In this case, the cutting component 30 presses the edges, referred to as scrap 54, into the pad 32, thereby compressing the lower springs 36. In this embodiment, the cutting component 30 cuts through the entire thickness t of the blank 22, and the desired final shape of the blank 22 is achieved without any post-forming operation outside of the hot forming apparatus 28, such as laser trimming. In another embodiment, shown in FIG. 2B, only a portion of the thickness t of the blank 22 is cut by the cutting component 30 in the hot forming apparatus 28. For example, the cutting component 30 may cut through not greater than 95%, for example 75% to 95%, or 90% of the thickness t of the steel blank 22. In this case, the scrap 54 remains attached to the blank 22, but is easily removed from the part 20 outside of the hot forming apparatus 28.

An alternate embodiment of the hot forming apparatus 128 is shown in FIG. 3. The method conducted using the forming apparatus of FIG. 3 is referred to as a “zero entry” method. In this embodiment, the hot forming apparatus 128 includes the cutting component 130 fixed to the first portion 138 of the upper die 124, without the upper springs 34, lower springs 36, and pad 32. The second portion 140 of the upper die 124 presents the recessed upper forming surface 142 and the third portion 144 of the lower die 126 presents the lower forming surface 146. However, unlike the hot forming apparatus 28 of FIGS. 2A and 2B, the cutting component 130 is fixed to the second portion 140 of the upper die 124, and the second portion 140 is fixed to the first portion 138. In addition, the upper forming surface 142 and the cutting component 130 provide an upper ledge 150 therebetween, and the lower forming surface 146 presents a lower ledge 152 aligned with the upper ledge 150 for shearing the heated blank 122. As in the embodiment of FIGS. 2A and 2B, the upper die 124 and cutting component 130 move downward, and the upper forming surface 142 presses the heated blank 122 around the lower forming surface 146 to a predetermined shape.

As alluded to above, in the embodiment of FIG. 3, the cutting component 130 does not move relative to the first portion 138 or the second portion 140 of the upper die 124. Instead, the upper ledge 150 of the upper die 124 moves toward the lower ledge 152 of the lower die 126 to shear the edges off the heated blank 122. Alternatively, the cutting component 130 could cut through less than 95% of the thickness t of the blank 122, such that the scrap 154 remains connected to the blank 122, but can be easily removed outside of the hot forming apparatus 128. In either case, the shearing step begins when the distance between the upper ledge 150 and lower ledge 152 is equal to the thickness t of the steel blank 122. As in the embodiment of FIGS. 2A and 2B, the forming and cutting steps occur in a single die stroke and while the microstructure of the blank 122 is substantially austenite.

In other embodiments, the cutting step can include trimming, piercing, or another type of cutting technique, instead of shearing, or in addition to shearing. Thus, the cutting component 30 of the hot forming apparatus 28 is designed accordingly. Preferably, the hot forming apparatus 28 is designed so that the cutting clearance, also referred to as the die clearance, is between 2% and 15% of the thickness t of the blank 22. In the embodiments of FIGS. 2A, 2B, and 3 the cutting clearance is equal to the distance between a cutting edge of the cutting component 30 and a cutting edge of the adjacent lower forming surface 46, when the hot forming apparatus 28 is closed.

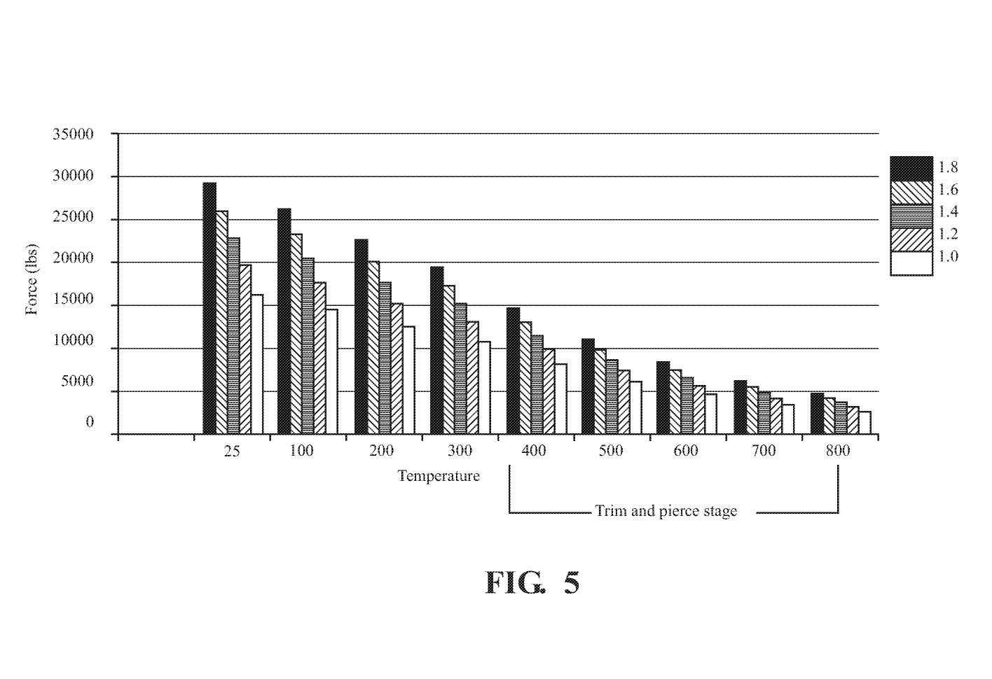

As stated above, the step of cutting the blank 22 occurs while the steel material is still at a temperature of at least 400° C., preferably 400° C. to 850° C., and still has a substantially austenite microstructure. FIG. 4 is a perspective view of an exemplary hot formed part 20, specifically a B-pillar, showing the approximate temperature profile along the part 20 at the start of the cutting step, which in this case includes trimming and piercing. The temperature profile indicates that the majority of the hot formed part 20 is at a temperature of at least 685° C. and the steel material is still 100% austenite at the start of the cutting step. FIG. 5 is a chart illustrating the load force applied to the hot formed part 20 by a 16 mm cutting component 30, such as a punch. The load force is provided for temperatures ranging from 25° C. to 800° C., and for part thicknesses t ranging from 1.0 to 1.8 mm. FIG. 5 also indicates that the temperature of the cutting step is from 400° C. to 800° C.

In order for the microstructure of the blank 22 to remaining substantially austenite during the cutting step, a quick process is required. In one embodiment, when the steel material includes 100% austenite during the cutting step, the amount of time from when the heated blank 22 exits the oven until forming the heated blank 22 between the forming surfaces 42, 46, i.e. the time at which the hot forming apparatus 28 is closed, is only 5 to 15 seconds. In another embodiment, when the steel material includes some retained austenite during the cutting step, but less than 100% austenite, the amount of time from when the heated blank 22 exists through the door of the oven until the hot forming apparatus 28 is closed is 5 to 20 seconds.

After the forming and cutting steps, the method includes cooling the blank 22 in the hot forming apparatus 28, while the hot forming apparatus 28 is still closed. The cooling step typically includes quenching. The hot forming apparatus 28 can include any type of cooling mechanism to cool or quench the hot formed blank 22. For example, the upper and lower dies 24, 26 could include a plurality of cooling channels for conveying a cooling fluid therethrough.

The hot formed blank 22 should be cooled or quenched at a rate that causes a martensite microstructure to form in the steel material, and preferably throughout the entire steel material so that the finished hot formed part 20 is 100% martensite. The martensite microstructure provides increased strength which is beneficial when the hot formed part 20 is used as an automotive body component, such as a B-pillar. In one embodiment, the method includes cooling the hot formed blank 22 at a minimum cooling rate of 27 degrees per second to obtain the martensite microstructure throughout the steel material. The method finally includes opening the hot forming apparatus 28 once the temperature of the hot formed part 20 is 200° C. or lower, and allowing the hot formed part 20 to cool to room temperature. Since the cutting step is performed in the hot forming apparatus 28, the method does not require any costly post-forming operations outside of the hot forming apparatus 28, such as a separate laser cutting process. If the scrap 54 remains attached to the hot formed part 20, a simple and inexpensive post-forming operation can be used to remove the scrap 54.

The invention also provides a hot formed part 20 manufactured using the method and hot forming apparatus 28 described above. The hot formed part 20 is manufactured by forming the heated blank 22 to a predetermined shape and then trimming, piercing, shearing, or otherwise cutting the blank 22 in the hot forming apparatus 28 to achieve a desired shape. Thus, there is no need for a costly post-forming operation, such as laser trimming. The hot formed part 20 preferably includes a martensite microstructure throughout the steel material with no residual carbides in the steel material, which could decrease the ultimate tensile strength (UTS) of the part 20. In addition, the hot formed part 20 can optionally include a diffusion layer comprising AlSi. In one embodiment, the hot formed part 20 has a yield strength of 500 MPa to 1,600 MPa; an ultimate tensile strength (UTS) of 900 MPa to 2,000 MPa; an elongation of 5.0%, minimum; and a hardness (HRV) of 300 to 600. The hot formed part 20 can be designed for use as any type of automotive body component, such as a pillar, rocker, roof rail, bumper, or door intrusion beam of an automotive vehicle. In one embodiment, the hot formed part 20 is a B-pillar having the design shown in FIG. 4. Alternatively, the hot formed part 20 can be used in a non-automotive application.

Obviously, many modifications and variations of the present invention are possible in light of the above teachings and may be practiced otherwise than as specifically described while within the scope of the claims.

What is claimed is:

1. A method of hot forming a steel part, comprising the steps of:
heating a blank formed of steel material to a temperature of 880° C. to 950° C.;
maintaining the blank at the temperature of 880° C. to 950° C. until the microstructure of the steel material is substantially austenite;
disposing the blank on a lower forming surface of a lower die and spaced from an upper forming surface of an upper die while the blank is at a temperature of at least 400° C. and the microstructure of the blank is substantially austenite, wherein the upper die is coupled to a cutting component, and the cutting component is disposed adjacent the upper forming surface;
bringing the upper die toward the lower die;
the step of bringing the upper die toward the lower die including bringing the upper forming surface of the upper die into contact with the blank to form the blank between the upper and lower forming surfaces;
the step of bringing the upper die toward the lower die including moving at least a portion of the upper die and the cutting component together longitudinally until the cutting component cuts at least a portion of the blank;
the cutting step being conducted while the blank is at a temperature of at least 400° C. and the microstructure of the blank is substantially austenite; and
cooling the blank at a rate of at least 27 degrees per second while the upper forming surface and the lower surface remain in contact with the blank and until the microstructure of the blank includes martensite.

2. The method of claim 1, wherein the cutting component cuts through not greater than 95% of the thickness of the blank during the cutting step.

3. The method of claim 1, wherein the cutting component cuts through the entire thickness of the blank during the cutting step.

4. The method of claim 1, wherein the cutting step occurs simultaneously with the forming step.

5. The method of claim 4, wherein the cutting component is fixed relative to the upper forming surface; the upper forming surface and the cutting component provides an upper ledge therebetween; the lower forming surface presents a lower ledge aligned with the upper ledge; and the cutting step includes moving the upper ledge toward the lower edge.

6. The method of claim 1, wherein the cutting step occurs after the forming step.

7. The method of claim 6, wherein the cutting component is moveable longitudinally relative to the upper forming surface, and the cutting step includes moving the cutting component longitudinally past the upper forming surface.

8. The method of claim 7, wherein a first portion of the upper die is coupled to the cutting component, a second portion of upper die presents the upper forming surface, the cutting component is movable relative to the second portion of the upper die, and the first portion of the upper die is biased away from the second portion.

9. The method of claim 8, wherein a pad is disposed adjacent the lower forming surface of the lower die beneath the cutting component, and the pad is biased toward the upper die.

10. The method of claim 1, wherein the blank is at a temperature of at least 685° C. and the microstructure of the blank is entirely austenite during the cutting step.

11. The method of claim 1, wherein the blank has a thickness, the upper and lower dies present a cutting clearance therebetween, and the cutting clearance is 2% to 15% of the thickness of the blank.

12. The method of claim 1, wherein the steel material of the blank comprises 0.18% to 0.28% carbon, 0.7% to 1.0% silicon, 1.0% to 2.0% manganese, 0.12% to 0.7% chromium, 0.1% to 0.45% molybdenum, 0.025% maximum phosphorus, 0.008% to 0.01% sulfur, 0.02% to 0.05% titanium, 0.01% to 0.06% aluminum, and 0.002% to 0.004% boron, based on the total weight of the steel material.

13. The method of claim 1, wherein a coating formed of aluminum and silicon is applied to the steel blank prior to the heating step.

14. The method of claim 1, wherein the cutting step includes at least one of trimming, piercing, and shearing the blank.

15. The method of claim 1, wherein steps of heating and maintaining the blank at the temperature of 880° C. to 950° C. until the microstructure of the steel material is substantially austenite occurs in an oven separate from the upper and lower dies, and further including the step of removing the heated blank from the oven and transferring the heated blank to the lower forming surface, wherein the amount of time between the step of removing the blank from the oven and the step of forming the blank between the upper and lower forming surfaces is 5 to 20 seconds.

16. The method of claim 1, wherein the steps of forming the blank between the upper and lower forming surfaces and cutting at least a portion of the blank occur during a single die stroke and while the microstructure of the blank is substantially austenite.

17. The method of claim 1, wherein the forming step is conducted while the blank is at a temperature of at least 400° C.

18. The method of claim 1, wherein after the cooling step, the blank has a yield strength of 500 MPa to 1,600 MPa, an ultimate tensile strength (UTS) of 900 MPa to 2,000 MPa, a minimum elongation of 5.0%, and a hardness (HRV) of 300 to 600.

19. The method of claim 1, wherein the steps of heating and maintaining the blank at the temperature of 880° C. to 950° C. until the microstructure of the steel material is substantially austenite includes maintaining the blank at the temperature of 880° C. to 950° C. for at least 30 seconds and until the microstructure of the steel material is at least 75% austenite.

20. A method of hot forming a steel part, comprising the steps of:
heating a blank formed of steel material to a temperature of 880° C. to 950° C. until the microstructure of the steel material is substantially austenite;
forming and cutting the blank between an upper die and a lower die while the blank is at a temperature of at least 400° C. and the microstructure of the blank is substantially austenite;
the forming an cutting steps being conducted during a single stroke of at least one of the dies; and
cooling the blank until the microstructure of the blank includes martensite.
